(19) United States
(12) Patent Application Publication
(10) Pub. No.: US 2020/0034495 A1
(43) Pub. Date: Jan. 30, 2020

(54) SYSTEMS, DEVICES, AND METHODS FOR GENERATING A DIGITAL MODEL OF A STRUCTURE

(71) Applicant: Northrop Grumman Innovation Systems, Inc., Plymouth, MN (US)

(72) Inventors: Kenneth B. Riding, Perry, UT (US); Ian Cox, Ogden, UT (US)

(21) Appl. No.: 16/048,097

(22) Filed: Jul. 27, 2018

(51) Int. Cl. G06F 17/50

(52) U.S. Cl. CPC G06F 17/50

(57) ABSTRACT

Methods and systems for generating a digital model of a structure indicate one or more characteristics of the structure in the model of the structure.

### FIELD

Embodiments of this disclosure relate generally to systems and methods for generating a digital model showing characteristics and/or features in composite structures. In particular, embodiments of this disclosure relate to systems, devices, and methods for inspecting structures, such as, for example, large complex composite structures, identifying characteristics and/or features in the structures, and generating a digital model of the structures showing the characteristics and/or features in the structures.

### BACKGROUND

Nondestructive testing (NDT) includes a wide array of analysis techniques used to evaluate properties, materials, components, and systems without causing damage. Ultrasonic testing is one method of nondestructive testing. Ultrasonic testing involves using generation of sound waves to inspect objects by directing the waves into an object and detecting reflected and refracted sound waves emanating from the object. The object tested may be comprised of different types of materials. For example, the materials may be one or more of steel, metals, alloys, concrete, wood, composite materials, and other types of materials.

During ultrasonic testing, transducers send sound waves (e.g., very short pulses) (e.g., typically between 0.1 MHz and 100 MHz) into an object to be tested. Second sound waves (e.g., echoes) are received as a response to the first sound waves sent into the object. The response is analyzed for a number of different purposes. For example, the analysis may be used to characterize materials in the object, identify defects, and for other purposes.

Determining whether defects are present is important at multiple stages during the lifecycle of an object. Nondestructive testing is important, for example, immediately after manufacturing the object, after protracted storage of the object, while the object is in use, and during maintenance.

Conventionally, ultrasonic testing results in a “C-scan” or spatial map showing signal responses of interest in the context of the object. A C-scan is a two-dimensional presentation of data displayed as a top or planar view of a test piece, similar in its graphic perspective to an X-ray image, where color represents the gated signal amplitude or depth at each point in the test piece and mapped to its position. Planar images can be generated on flat parts by tracking the X-Y position, or on cylindrical parts by tracking axial and angular position. For conventional ultrasound, a mechanical scanner with encoders is used to track the transducer's coordinates to the desired index resolution.

### BRIEF SUMMARY

In some embodiments, the present disclosure includes a system for generating a digital model of a structure indicating at least one characteristic of the structure. The system may comprise an inspection system configured to detect structural information of the structure through a depth of the structure and to generate model depth data and detect the at least one characteristic of the structure and generate characteristic data. The system further includes a location system in communication with the inspection system. The location system is configured to track a location of the at least a portion of the inspection system relative to the structure and generate inspection system location data and the location data comprises data relating to a position of the at least a portion of the inspection system relative to the structure along at least three degrees of freedom and a data processing system in communication with the inspection system and the location system. The data processing system is configured to generate the digital model of the structure using the model depth data, the characteristic data, and the location data in which an indication of the at least one characteristic is visible in the digital model, wherein one or more locations of the at least one characteristic in the digital model substantially correspond to one or more locations of the at least one characteristic in the structure.

In still other embodiments, the present disclosure includes a system for generating a digital three-dimensional model of a structure showing one or more defects in the structure. The system may comprise an inspection device comprising a platform configured to move along a surface of the structure and a transducer system configured to send signals into the structure and receive a response to the signals from the structure. The system further includes a positional tracker in communication with the inspection device and a data processing system in communication with the positional tracker and with the inspection device. The inspection device is configured to detect structural information including the one or more defects in the structure and generate structural information data. The positional tracker is configured to generate inspection device location data, the location data comprising data relating to a position of the inspection device about six degrees of freedom of the inspection device. The data processing system is configured to generate the digital three-dimensional model of the structure using the structural information data and the location data in which an indication of the one or more defects is indicated in the digital model at a location within the digital model that substantially corresponds to a location of the one or more defects in the structure.

In still other embodiments, the present disclosure includes a method for generating a digital model of an object indicating discontinuities in the object. The method may comprise moving an ultrasonic inspection device along a surface of the object, detecting, with the ultrasonic inspection device, the one or more discontinuities in the object from a response from the ultrasonic inspection device, generating discontinuity data based on a response from the ultrasonic inspection device, communicating, with the ultrasonic inspection device, the discontinuity data to a data processing system remote from the ultrasonic inspection device, tracking a location of the ultrasonic inspection device relative to the object and generating location data with a tracking system, communicating the location data to the data processing system; and generating, with the data processing system, the digital model using the discontinuity data and the location data in which an indication of the one or more discontinuities is visible in the digital model and a location of the one or more discontinuities in the digital model is positioned in the model substantially at a location of the one or more discontinuities in the object.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is an embodiment of a system for generating a digital model of an object according to the disclosure;

FIG. 2 is an embodiment of a display produced by a portion of a system for generating a digital model according to the disclosure;

FIG. 3 is an embodiment of a data processing system according to the disclosure; and

FIG. 4 is an embodiment of a method for generating a digital model of a structure according to the disclosure.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, system, and process changes may be made without departing from the scope of the disclosure. The illustrations presented herein are not meant to be actual views of any particular process, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, structure, configuration, logic, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

Furthermore, specific implementations shown and described are only examples and should not be construed as the only way to implement the present disclosure unless specified otherwise herein. Elements, connections, circuits, and functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, symbols, and chips that may be referenced throughout this description may be represented by voltages, currents, electromagnetic waves, magnetic fields or particles, optical fields or particles, or any combination thereof. Some drawings may illustrate information and signals as a single data packet or single signal for clarity of presentation and description. It will be understood by a person of ordinary skill in the art that the data packet or signal may represent a bus of signals or series of data packets. A bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a digital signal processor (DSP), an integrated circuit (IC), an application specific integrated circuit (ASIC), a field programmable gate array (FPGA) or other programmable logic device, discrete gate or transistor logic, discrete hardware components, or any combination thereof designed to perform the functions described herein.

A general-purpose processor may be a microprocessor or any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure. Examples of computers include personal computers, workstations, laptops, tablets, mobile phones, wearable devices, and computer-servers.

The embodiments may be described in terms of a process that is depicted as a flowchart, a flow diagram, a structure diagram, or a block diagram. Although a flowchart may describe operational acts as a sequential process, many of these acts may be performed in another sequence, in parallel, or substantially concurrently. In addition, the order of the acts may be rearranged. A process may correspond to a method, a thread, a function, a procedure, a subroutine, a subprogram, etc. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Many of the functional units described may be illustrated, described or labeled as modules, threads, or other segregations of programming code, in order to more particularly emphasize their implementation independence. Modules may be at least partially implemented in hardware, in one form or another. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented using software or firmware, stored on a physical storage device (e.g., a computer-readable storage medium), in memory, or a combination thereof for execution by various types of processors. An identified module of executable code may, for instance, comprise one or more physical or logical blocks of computer instructions, which may, for instance, be organized as a thread, object, procedure, or function. Nevertheless, the executable of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several storage or memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more physical devices, which are referred to herein as computer-readable media.

In some embodiments, the software portions are stored in a non-transitory state such that the software portions, or representations thereof, persist in the same physical location for a period of time. Additionally, in some embodiments, the software portions are stored on one or more non-transitory storage devices, which include hardware elements capable of storing non-transitory states and/or signals representative of the software portions, even though other portions of the non-transitory storage devices may be capable of altering and/or transmitting the signals. Examples of non-transitory storage devices are flash memory and random-access-memory (RAM). Another example of a non-transitory storage device includes a read-only memory (ROM) which can store signals and/or states representative of the software portions for a period of time. However, the ability to store the signals and/or states is not diminished by further functionality of transmitting signals that are the same as or representative of the stored signals and/or states. For example, a processor may access the ROM to obtain signals that are representative of the stored signals and/or states in order to execute the corresponding software instructions.

As used in this specification, the terms “substantially,” “about,” and “approximately” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

The phrase “at least one of” when used with a list of items means different combinations of one or more of the listed items may be used and only one of each item in the list may be needed. For example, “at least one of item A, item B, and item C” may include, without limitation, item A or item A and item B. This example may also include item A, item B, and item C, or item B and item C. In other examples, “at least one of” may be, without limitation, two of item A, one of item B, and 10 of item C; four of item B and seven of item C; and other suitable combinations.

As used in this disclosure, any relational term, such as “first,” “second,” “over,” “top,” “bottom,” “side,” etc., is used for clarity and convenience in understanding the disclosure and accompanying drawings and does not connote or depend on any specific preference, orientation, or order, except where the context clearly indicates otherwise.

When one component is “associated” with another component, the association is a physical association in these examples. For example, a first component may be considered to be associated with a second component by being secured to the second component by welding, fasteners or connected to the second component in some other suitable manner. The first component may also be connected to the second component using a third, intervening component by which the first component may also be considered to be associated with the second component.

Embodiments of the disclosure may relate generally to systems and methods system for generating a digital three-dimensional (3D) model showing characteristics and/or features in various structures, such as, for example, large complex composite structures.

In some embodiments, various metrology instruments, such as portable laser trackers, laser scanners, triangulation scanners and articulated arm coordinate measuring machines (AACMMs) may be implemented in the inspection process. Such instruments may be utilized in the manufacturing or production of components and assemblies where there is a need to rapidly and accurately verify the dimensions and/or integrity of the part during various stages of manufacturing or production (e.g., machining). In particular, the implementation of portable metrology instruments may provide a significant improvement over known stationary or fixed, cost-intensive and relatively difficult to use measurement installations, particularly in the amount of time it takes to perform dimensional measurements of relatively complex parts. In the instance of a laser tracker, an operator simply guides a probe along the surface of the part or object to be measured. The measurement data are then recorded and provided to the user. In some cases, the data are provided to the user in visual form, for example, three-dimensional (3D) form on a computer screen.

In various embodiments, an operator runs an inspection device along and in contact with a surface of an object to be inspected and modeled. In some embodiments, the inspection device may be a handheld device. While the operator runs the inspection device along the surface of the object, a metrology instrument, such as, for example, a laser tracking system, or other suitable location system, tracks the location of the inspection device with at least three degrees of freedom. For example, the laser tracking system may track the location of the inspection device with six degrees of freedom (x, y, z, i, j, k), including actual coordinates or axes (x, y, z) (e.g., axes of translation) relative to the laser tracking system, another suitable location system, or other suitable point of origin and pitch, yaw, and roll (i, j, k) data (e.g., rotation about the three axes). A data processing system receives characteristic data relating to the object from the inspection device and the location data from the laser tracking system, or other suitable location system, and generates a digital three-dimensional model of the object. The three-dimensional model displays at least one characteristic of the object detected by the inspection device positioned in the 3D model approximately at the actual location of at least one characteristic in the object. Embodiments of the disclosure provide enhanced systems and methods that may substantially increase the speed of inspection data acquisition for relative large structures (e.g., having relatively large surface area to be scanned and/or complex composite structures). The foregoing are merely examples and one of ordinary skill in the art will recognize many features and advantages of the present disclosure.

The illustrations presented in this disclosure are not meant to be actual views of any particular system or device, but are merely idealized representations that are employed to describe the disclosed embodiments. Thus, the drawings are not necessarily to scale and relative dimensions may have been exaggerated for the sake of clarity. Additionally, elements common between figures may retain the same or similar numerical designation.

The following description provides specific details in order to provide a thorough description of embodiments of this disclosure. However, a person of ordinary skill in the art will understand that the embodiments of this disclosure may be practiced without employing these specific details.

The illustrations presented in this disclosure are not meant to be actual views of any particular system for generating a digital model, but are merely idealized representations employed to describe illustrative embodiments.

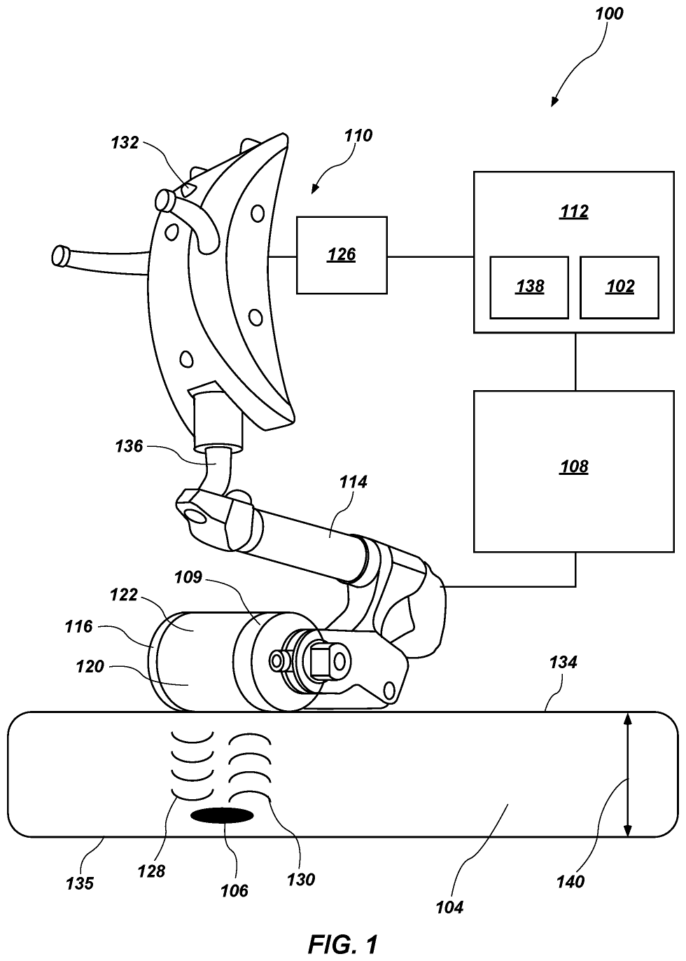

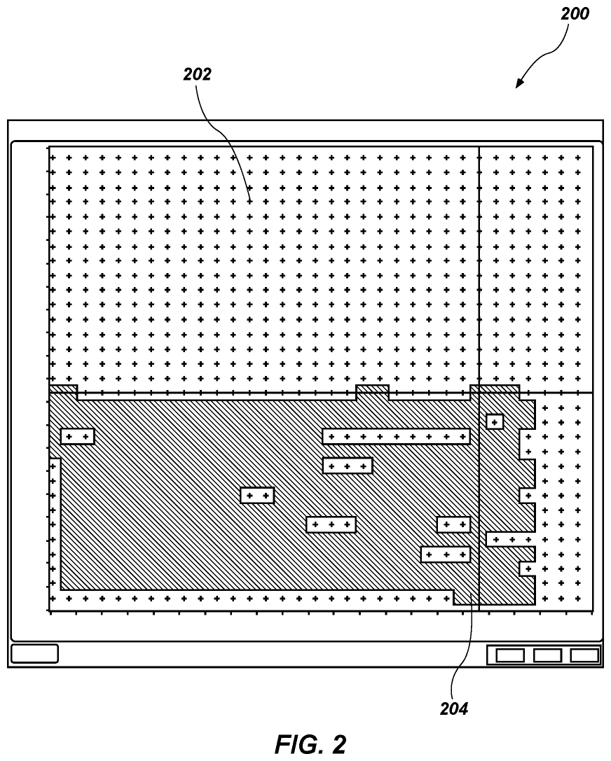

FIG. 1 depicts an embodiment of a system 100 for generating a digital model 102 of an object or structure 104 showing one or more characteristics 106 (e.g., a structural characteristic, which may include one or more characteristics of the materials defining the object or structure 104) of the structure 104 in at least an approximate or substantially exact positioning of the characteristic 106 in the structure 104. The system 100 may comprise an inspection system 108 including an inspection device 109, a location system 110, and a data processing system 112.

As depicted, one or more portions of the location system 110 may be part of (e.g., coupled to, carried by) the inspection system 108 (e.g., the inspection device 109). As discussed below in greater detail, the location system 110 may comprise a probe or target point 132 (e.g., a wireless probe) that communicates with another portion of the location system 110, which may be coupled to or remote from the inspection system 108, and/or directly in communication with the data processing system 112 in order to provide location data relating to the position of the inspection device 109.

The object 104, which may also be characterized as a structure, to be inspected and modeled may take various forms. For example, the structure 104 may comprise an aerospace structure such as, for example, an aircraft, or a component part thereof, such as an engine housing, a fuselage, a wing, a composite airfoil, a composite skin panel, a metal skin panel, a vertical stabilizer, a horizontal stabilizer, a joint, portions thereof, and/or some other component. Structure 104 may also, for example, comprise some other mobile platform or a stationary platform in the form of a land-based structure, an aquatic-based structure, a space-based structure, a submarine, a bus, a personnel carrier, a tank, a train, an automobile, a spacecraft, a space station, a surface ship, or other suitable object.

In some embodiments, the inspection device 109 may comprise an ultrasonic inspection device and/or system. For example, the ultrasonic inspection device 109 may comprise a mobile or handheld configuration or platform (e.g., structural and/or mechanical design of an inspecting device), such as, for example, a mobile platform 114, and a detection system 116 configured to detect one or more characteristics 106, as discussed below. In other embodiments, the inspection device 109 may comprise a stationary system (e.g., where the structure 104 is moved along the inspection device 109).

In such an embodiment, the inspection system 108 may include an ultrasonic pulser and receiver configured to communicate with the inspection device 109 comprising an ultrasonic probe.

The platform 114 may be selected from one of a handheld platform, portable platform, motorized platform, or other suitable configurations. For example, a handheld platform may be a platform that may be operated by one or more hands of an operator. A portable platform may be a platform movable by the operator or more than one operator. A motorized platform may be a platform that may move without force applied by the operator, for example a robotic platform.

In some embodiments, the transducer system 120 may associated with one device or platform 114 or on multiple separate devices or platforms 114.

In some embodiments, one or more portions of the location system 110 (e.g., the target point 132) may be coupled (e.g., directly coupled) to the platform 114 by a mechanical coupler 136. The mechanical coupler 136 may be configured to place one or more portions of the platform 114 in communication with one or more portions of the location system 110 (e.g., may including a coupling configured to pass electrical signals through the coupler 136 between the platform 114 and the location system 110.

The detection system 116 of the ultrasonic inspection device 109 may comprise a transducer system 120. The transducer system 120 may be configured to contact a proximal surface of the structure 104, send signals 128 (e.g., acoustic sound) in the form of sound waves into the structure 104, through a thickness or depth 140 of the structure 104, and to receive response signals 130 (e.g., return acoustic sound) to the transmitted signals 128. The transmitted signals 128 travel through the depth 140 of the structure 104 to detect internal or underlying structural information relating to the structure 104.

When the transmitted signals 128 travel through the depth 140 of the structure 104 without encountering any specific unexpected or undesirable characteristics 106 (e.g., anomalies, defects, etc.) in the structure, the transmitted signals 128 will generally travel from the surface 134 (e.g., the proximal surface 134) of the structure 104 to a distal surface 135 of the structure 104 remote from the location of the transducer system 120 and reflect back from the distal surface 135 in the form of the response signals 130. When the transmitted signals 128 encounter the one or more characteristics 106 in the structure 104, the transmitted signals 128 will generally travel from the proximal surface 134 of the structure 104 a distance less than the depth 140 of the structure 104 and reflect back from the one or more characteristics 106 in the form of the response signals 130.

The location (e.g., depth from the surface 134 of the structure 104) of the one or more characteristics 106 in the structure 104 may be determined by monitoring the transit time of the transmitted signals 128 and the resulting response signal from and back to the surface 134 of the structure 104. The two-way transit time measured may be divided by two to account for the down-and-back travel path and multiplied by the velocity of sound in the material of the structure 104 to determine the depth of the one or more characteristics 106. The depth 140 of the surrounding structure 104 may be detected in a similar manner to produce the 3D model 102 of the structure 104.

In some embodiments, the frequency of the sent signals 128 transmitted by the transducer system 120 may be, for example, from about 0.1 MHz to about 100 MHz (e.g., 0.1 MHz to about 10 MHz), depending on the particular implementation.

The transducer system 120 may include a cylindrical housing 122 and an array of transducers, for example, enclosed in the housing 122. The transducer system 120 may be arranged along a line (e.g., a straight line) in an arc (e.g., a fixed radius), or a two-dimensional array. The transducer system 120 may be comprised of different types of transducers, for example, the transducers may include at least one of mechanical transducers, electrical transducers, piezoelectric transducers, magnetostrictive transducers, and/or other suitable types of transducers, the transducers oriented to emit and receive signals in a common direction perpendicular to a line along which the transducers are arranged.

The housing 122 is configured to move over (e.g., roll over or on) the surface 134 of the structure 104. For example, the cylindrical housing 122 may function as a roller. The roller may be part of a locomotion system for the moving platform 114 on the surface 134 of the structure 104, as shown, while transducer system 120 remains at a fixed orientation for targeting structure 104. In other words, housing 122 is rotatably secured about transducer system 120.

The cylindrical housing 122 may be rigid or deformable. The cylindrical housing 122 may be comprised of one or more materials that are conducive to the transmission of signals generated by the array of piezoelectric transducers within the cylindrical housing 122. An acoustic coupling fluid may be present within the cylindrical housing 122.

As depicted, the platform 114 may be a handheld platform where the detection system 116, transducer system 120, and the target point 132 are associated with the platform 114.

In some embodiments, the inspection device 109 may comprise the Olympus ROLLERFORM®, commercially available from Olympus IMS. In some embodiments, the inspection device 109 may comprise a phased array wheel probe designed to inspect composites and other smooth-surface materials, such as those commonly used by the aerospace industry.

In other embodiments, the inspection device 109 may comprise a handheld X-ray fluorescence analyzer. Additional examples of inspection devices 109 may include ultrasonic flaw detectors, phased array flaw detectors, eddy current flaw detectors, bond testing flaw detectors, and other suitable inspection devices 109 and/or inspection systems 108.

In some embodiments, where the inspection system 108 includes multiple components or portions, the inspection system 108 may include the target point 132 of the location system 110 that is associated with the platform 114. The target point 132 may comprise a retro-reflective target, such as, for example, a spherically mounted retro-reflector (SMR). The target point 132 may enable the inspection system 108 to be tracked by another portion of the location system 110 (e.g., a laser tracker 126 positioned external to the platform 114) while the inspection system 108 is moved along (e.g., on) the surface of the object or structure 104. As depicted, one or more portions of the location system 110 (e.g., the laser tracker 126, the target point 132, or both) may be in communication with the data processing system 112.

In use, the laser tracker 126 may send a laser beam to the target point 132 positioned on the inspection system 108. Light reflected off the target point 132 retraces its path, re-entering the laser tracker 126 at the same position it left. As light re-enters the laser tracker 126, some of the light is captured by a distance meter that measures the distance from the laser tracker 126 to the target point 132. The distance meter may be an interferometer, an absolute distance meter, or some other suitable time of distance meter.

In some embodiments, the target point 132 may be a Leica T-Probe manufactured and sold by Hexagon Manufacturing Intelligence (available online at hexagonmi.com), which is configured to be utilized with a laser tracking system, such as, for example, the Leica ABSOLUTE TRACKER® AT960.

The data processing system 112 may be configured to generate the 3D model 102 of the object or structure 104 using both the data detected by the inspection device 109 relating the characteristics 106 of the structure 104 (e.g., structure characteristic data) and the location data. As depicted, the data processing system 112 may be located remote to the inspection system 108. For example, the data processing system 112 generates the 3D model 102 using structure characteristic data provided by the inspection system 108 and the location data provided by the location system 110. As above, the structure characteristic data may comprise the response signals 130 to the transmitted signals 128, which indicate characteristics 106 (e.g., anomalies, defects) in and/or on the structure 104.

In some embodiments, the system 100 may include a synchronization device 138 (e.g., an electronic triggering synchronization device), which may be part of the data processing system 112 or separate from while still being in communication with the data processing system 112, the inspection system 108, and the location system 110. As discussed below, the synchronization device 138 may send signals to components of the system 100 (e.g., the inspection system 108 and the location system 110) and data from the components (e.g., inspection and/or location data) may be sent (e.g., to the data processing system 112) in response to the trigger signals.

In some embodiments, one or more of the inspection system 108 or the location system 110 may include local storage for storing data from the respective one of the inspection system 108 or the location system 110.

The digital 3D model 102 may be generated by developing a mathematical representation of any surface of the structure 104. The 3D model 102 may be generated using 3D computer graphics software, 3D modeling applications, and/or 3D modelers.

The 3D model 102 may represent the physical structure 104 using a collection of points in 3D space, connected by various geometric entities such as triangles, lines, curved surfaces, etc. The 3D model 102 may be viewed from various directions, angles, and views. Seeing the object or structure 104 from multiple perspectives may enable the viewer to see changes or improvements that need to be made to the object or structure 104.

The 3D model 102 may be configured to display the external topography of the structure 104 to be modeled and also one or more characteristics 106 within the model 102. The 3D model 102 may include an adaptation of a conventional C-scan. For example, the 3D model may have different colors or grayscales, representing one or more different characteristics 106 in the structure 104.

In some embodiments, the 3D model may be utilized to compare the scanned structure 104 and a model (e.g., a computer model) of the structure 104 so that discrepancies between the two models may be identified.

The one or more characteristics 106 may be located on a surface 134 of the structure 104 or below the surface 134. The characteristics 106 may take various forms depending on the particular application. For example, if the structure 104 is comprised of composite materials, the characteristics 106 identified may include a delamination, a resin pocket, and/or some other type of unexpected or undesirable characteristic in the structure.

In some embodiments, the one or more characteristics and/or features of the structure may include one or more of a structural feature, a defect, a pocket of unexpected material, a volume lacking an expected material, an inconsistency, an anomaly, a void, an air bubble, a delamination, a resin pocket, a structural feature, a volume lacking an expected material, an unexpected change in material and/or structure, a discontinuity, an anomaly, material change, a density change, some other type of change in the structure, or combinations thereof. It is noted that, when no undesirable characteristics are present, such one or more characteristics and/or features of the structure may include expected structural information.

The inspection system 108 may comprise a device configured to inspect the structure 104 and to generate data about the structure 104 to be included in the 3D model 102. The inspection system 108 may be used to perform nondestructive testing. For example, nondestructive testing methods may include, without limitation: ultrasonic testing, electromagnetic testing, eddy current testing, magnetic-particle inspection, liquid penetration inspection, penetrant testing, radiographic testing, and any other suitable type of nondestructive testing.

The location system 110 may be configured to identify and track a location of the inspection system 108 on the surface 134 of the structure 104. In some embodiments, the location system 110 may be located remotely to the inspection system 108. The location system 110 may be used to track the location of the inspection system 108 relative to the location system 110 or some other suitable point of origin. In additional embodiments, the location system 110 may be located with (e.g., integrated with) the inspection system 108. In additional embodiments, one portion of the location system 110 may be located with (e.g., integrated with) the inspection system 108 while another portion of the location system 110 is remote from the inspection system 108.

The location system 110 may be of various configurations configured to track the location of the structure 104 being inspected such that the data received from the inspection may be associated with that location. For example, the location system 110 may comprise at least one of a laser tracking system, an encoder system, a video sensor system, a global positioning system, and/or other suitable types of components.

As depicted, the location system 110 may be configured to generate location data relating to the inspection system 108 (e.g., the inspection device 109) on the surface 134 of the structure 104. The location data tracks movement of the inspection device 109 relative to the structure 104. The location data may include translation data (e.g., linear movement data) along three axes of movement (x, y, z) relative to the location system 110 or some other suitable point of origin. The location data may further comprise rotational data (i, j, k) of the inspection system 108 about the three axes of movement (x, y, z). In some embodiments, the location data may include a distance and/or direction (e.g., a vector) the inspection system 108 has moved and/or some other suitable type of information, which may be represented in spherical or radial coordinate systems. In embodiments where the inspection device 109 is fixed, the location system 110 may track the location of the structure 104.

The data processing system 112 may be configured to generate the 3D model 102 of the structure 104 using both the data detected by the inspection device 109 relating the characteristics of the structure 104 (e.g., structure characteristic data) and the location data.

The data processing system 112 may be configured to generate various icons indicating in the 3D model 102 various characteristics 106 within the modeled object or structure 104. The data processing system 112 may also be configured to generate various notifications and/or alerts indicating in the 3D model 102 various characteristics 106 within the modeled object or structure 104. In some embodiments, the data processing system 112 may be configured to generate graphical representations, including 2D and 3D graphical representations, indicating within the model 102 and/or modeling the various characteristics 106 within the modeled object or structure 104. The various characteristics 106 may include structural characteristics, which may include characteristics of the materials defining the object or structure 104, as discussed above.

For example, as shown in FIG. 2 and also referring to FIG. 1, a portion of the system 100 (e.g., the location system 110, the data processing system 112) may track the movement of the inspection device 109 over the structure 104. The system 100 may define (e.g., and display on the visual display 200 shown in FIG. 2) a representation of the area to be scanned (e.g., a grid 202) including an indication of the scanned areas 204 that have already been scanned by the inspection device 109.

In some embodiments, a user may start a scanning process by registering a number of points (e.g., three points) on the structure 104 to define a projection plane of the structure 104.

As the structure 104 is being scanned, portions of the grid 202 corresponding to areas of the structure 104 may provide an indication that the scan is complete in these areas (e.g., by blacking out the scanned areas 204. In some embodiments, the grid 202 may indicate any missing portions of one or more of the scanned areas of the surface 134 along with the volume of the structure 104 underlying the surface 134 (e.g., the volume extending from the proximal surface 134 to the distal surface 135 along the depth 140).

During scanning of the structure 104, the location system 110 determines and transmits an area or point of location of the inspection device 109 on the adjacent, near, or proximal surface 134. The inspection device 109 may scan the structure 104 (e.g., through the depth 140 of the structure 104) along a line or lines emitting from the area or point determined by the location system 110. For example, the inspection device 109 may scan the structure 104 along the line or lines through the depth 140 and from the surface 134 to the opposing or distal surface 135 in order to determine a 2D line or 3D volume of a portion of the structure 104 at the area or point on the surface 134. Such a 2D line or 3D volume along with the position information from the location system 110 may be utilized to form the 3D model 102 of the structure 104 by supplying a portion of the system 100 (e.g., the data processing system 112 data relating to the depth 140 of the structure 104. For example the inspection device 109 may transmit model depth data (e.g., in the form of ultrasonic waveforms) to the inspection device 109.

It is noted that, in embodiments where an array of transducers is implemented, the inspection device 109 may record data from multiple lines (e.g., cumulatively forming a two-dimensional plane and/or a polygon shape, such as a rectangle, or a 3D volume, such as a rectangular cuboid).

The recorded orientation of the six degrees of freedom of the location system 110 may extrapolate the direction of the line or lines in space as they extend away from the point at the adjacent surface to the opposing surface. Any characteristics 106 of the structure 104 along the line or lines may be determined by the inspection device 109 and are recorded by the software as the model is formed simultaneously with the 3D model of the adjacent surface being correlated with the inspection data from the inspection device 109 (e.g., including data through the depth 140 of the structure extending away from the point recorded by the location system 110). In some embodiments, the recorded orientation of the location system 110 may include a time when the structure 104 is scanned, which may be utilized to compare scans taken at different times.

A portion of the inspection device 109 (e.g., a mechanical encoder configured to detect movement of a portion of the inspection device 109, such as, for example, rotation of the housing 122) may act to generate a position change signal when the inspection device 109 is moved across or along the surface 134 of the structure 104. This position change signal may be received by the data processing system 112 and converted to a trigger signal (e.g., generated from the synchronization device 138) for one or more of the inspection device 109 and the location system 110. In some embodiments, the trigger signal may be provided directly from the inspection device 109 to the synchronization device 138.

In response to the trigger signal, ultrasonic data may be collected by inspection device 109 at the same time that six degrees of freedom positional data is recorded by the location system 110. The data processing system 112 may receive, store, and/or process these two data packets. The data processing system 112 may use this data to record and construct a real time surface generated from the six degrees of freedom data (e.g., the surface 134 of the structure 104) in which each point on the surface 134 is associated with (e.g., coupled with) ultrasonic waveform data from the inspection device 109.

As noted above, in a conventional inspection of a structure (e.g., an ultrasonic inspection), a 2D view of the ultrasonic wave amplitudes is provided as a so-called “C-scan.” In such a C-scan, geometries with curvature in three dimensions are projected on to a 2D plane for representation purposes. However, the system 100 (e.g., the data processing system 112) builds a 3D C-scan, enabling a user to simultaneously view the 3D geometry of the structure 104 with any characteristics 106 (e.g., defects) displayed in the 3D model 102 in their approximate or exact positions, as opposed to 2D approximations of the structure 104. Such a system 100 enables for the real time or on-the-fly building of a 3D model where previous inspection systems generally require the structure to be scanned before the inspection or a premade model loaded into the inspection system.

In some embodiments, when duplicate data is collected (e.g., by passing over the same area of the surface 134 of the structure 104 multiple times), the system 100 (e.g., the data processing system 112) may be configured to evaluate the new ultrasonic waveform data (e.g., by comparing the new data to existing stored data) in order to determine if the new data will replace the existing data relating to the scanned area (e.g., when the new data is determined to be a higher quality scan of the structure 104).

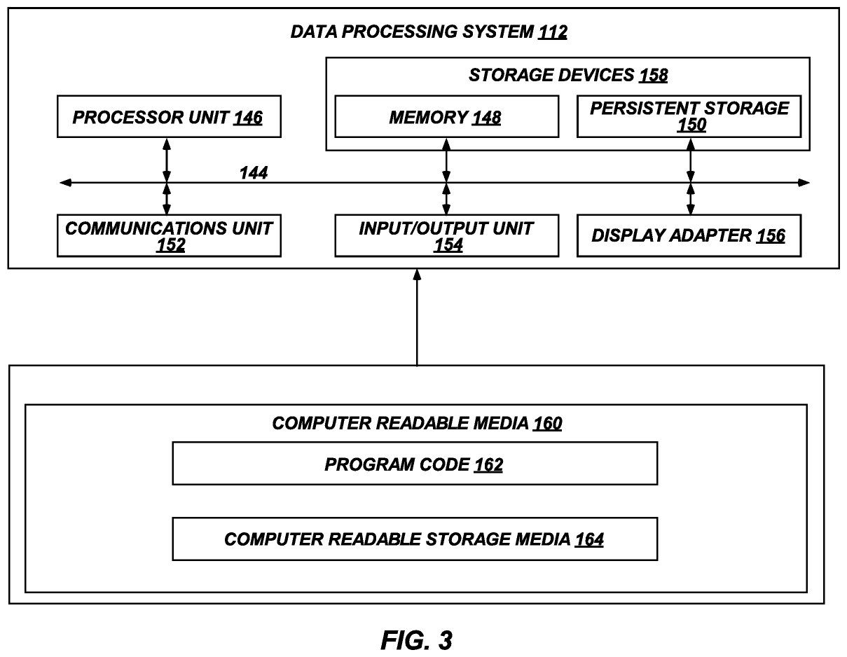

FIG. 3 depicts an embodiment of a data processing system 112 in schematic form. The data processing system 112 may comprise a communications framework 144, for providing communications between a processor unit 146, memory 148, persistent storage 150, a communications unit 152, an input/output unit 154, and a display adapter 156. In FIG. 3, the communications unit 152 may take the form of a bus system.

The processor unit 146 may execute software instructions loaded into memory 148. The processor unit 146 may be a number of processors, a multi-processor core, or some other type of processor.

Memory 148 and persistent storage 150 are examples of storage devices 158. A storage device 158 is any piece of hardware that is capable of storing information, such as, for example, without limitation, data, program code in functional form, and/or other suitable information either on a temporary basis and/or a permanent basis. Storage devices 158 may be referred to as computer-readable storage devices in this disclosure. Memory 148 may be random access memory or any other suitable volatile or non-volatile storage device.

Persistent storage 150 may take various forms. For example, persistent storage 150 may comprise one or more components or devices. For example, persistent storage may be a hard drive, a flash memory, a rewritable optical disc, or some combination of the above.

The communications unit 152 may be used to provide communications with other data processing systems or devices that may be connected to the data processing system 112. The communications unit 152 may comprise a network interface card.

The input/output unit 154 may allow for input and output of data with other devices that may be connected to the data processing system 112.

The display adapter 156 may provide a mechanism to display information using a display device, such as a monitor.

Instructions for the operating system, applications, and/or programs may be located in the storage devices 158, which are in communication with the processor unit 146 through the communications framework 144. The processes of the different embodiments may be performed by the processor unit 146 using computer implemented instructions, which may be located in memory 148.

These instructions are referred to as program code 162, computer usable program code, or computer readable program code that may be read and executed by the processor unit 146. The program code 162 in the different embodiments may be embodied on different physical or computer-readable storage media, such as memory 148 or persistent storage 150.

Additionally, the program code 162 may be located in a functional form on computer-readable media 160 that may be selectively removable and may be loaded onto or transferred to the data processing system 112 for execution by the processor unit 146. The program code 162 and computer-readable media 160 form the computer program code 162. In one embodiment computer-readable media 160 may be computer readable storage media 164.

Computer readable storage media 164 may be a physical or tangible storage device used to store program code 162 rather than a medium that propagates or transmits program code 162. Alternatively, program code 162 may be transferred to the data processing system 112 over a wireless communications link.

The different components illustrated for the data processing system 112 are not meant to provide architectural limitations to the manner in which different embodiments may be implemented. The different illustrative embodiments may be implemented in a data processing system including components in addition to and/or in place of those illustrated for the data processing system 112. Other components show in FIG. 3 can be varied from the examples shown. The different embodiments may be implemented using any hardware device or system capable of running program code.

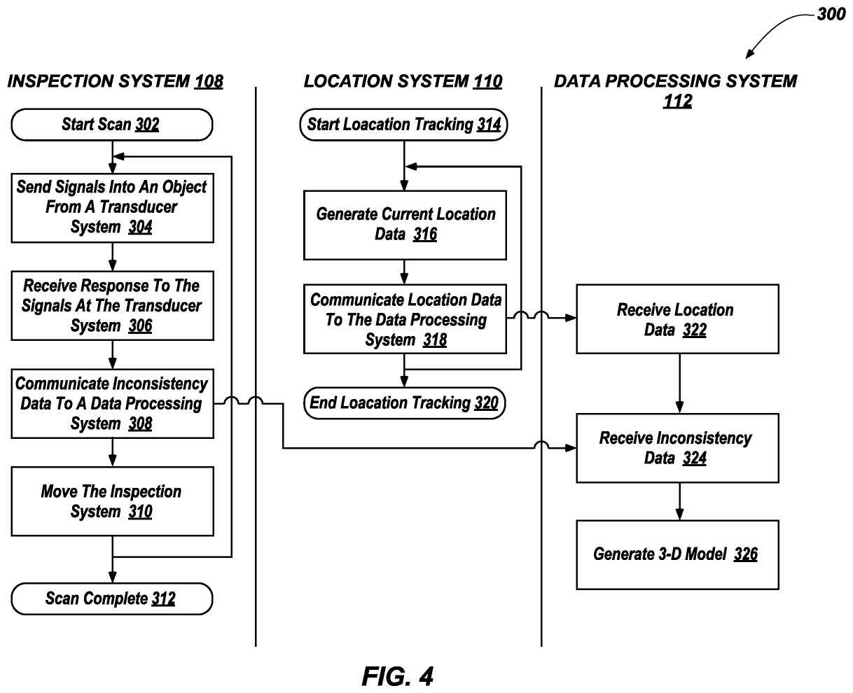

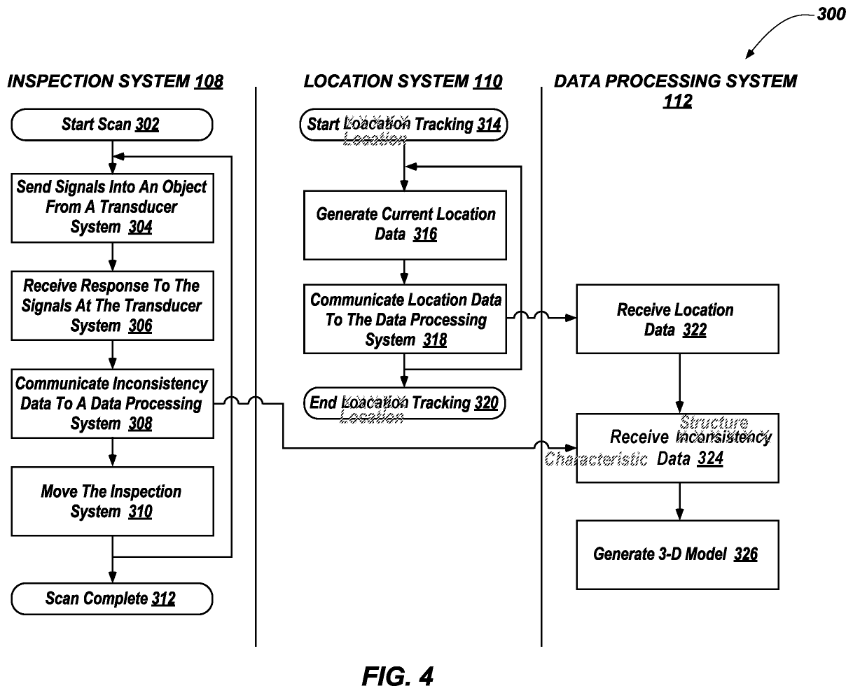

FIG. 4 depicts, in the form of a flow diagram, an embodiment of method 300 for generating a digital model of an object showing the inconsistencies (i.e., characteristics) of the object in the model. Reference is also made to FIG. 1 to refer to example components of the system 100 that may be implemented in some embodiments.

In operation, the scan starts at act 302 and the location tracking starts at act 314. At act 304, the transducer system 120 may send the transmitted signals 128 into the surface 134 of a structure 104. At act 306, the transducer system 120 may receive the response signals 130. At act 308, the transducer system 120 may communicate the structure characteristic data to the data processing system 112. The transducer system 120 may move to the next location at act 310 and repeat the steps outlined above until the scan is complete at act 312 (e.g., while the area being scanned is monitored by a process similar to that shown and described with reference to FIG. 2). The transducer system 120 may continuously or periodically send signals to the structure 104 as the ultrasonic inspection device 109 is moved along the surface 134 of the structure 104. The response signals 130 may constitute structure characteristic data. The structure characteristic data may be sent to the data processing system 112. At act 316, as the ultrasonic inspection device 109 is moved on the surface 134 of the structure 104, the laser tracker 126 may generate the location data. The location data may comprise actual coordinates of the ultrasonic inspection device 109 relative to the laser tracker 126 or relative to some other suitable point of origin. The location data may further comprise pitch, yaw, and roll (i, j, k) data of the ultrasonic inspection device 109. The location information may be sent to the data processing system 112 during or after the scan at act 318. The location tracking steps outlined above may also be repeated until the scan is complete 312 and the location tracking ends at act 320.

The data processing system 112 may receive the location data at act 322. The data processing system 112 may receive the structure characteristic data at act 324. The data processing system 112 may use the structure characteristic data and the location data to generate a digital three-dimensional model 102 of the structure 104 where the characteristics 106 may be indicated (e.g., highlighted, visible, indicated by a marker, etc.) in the digital 3D model 102 and the location of the characteristics 106 in the digital 3D model 102 may correspond (e.g., substantially correspond, directly correspond) to the location of the characteristics 106 in the model 326.

The three-dimensional model 102 may include an adaptation of a conventional C-scan in this embodiment. For example, the 3D model 102 may have different colors or grayscales, depending on the characteristic data, i.e., the response received from the signals. The 3D model 102 may also include various different icons indicating various different characteristics 106 within the modeled object or structure 104. The digital 3D model 102 may also include various notifications and/or alerts indicating various characteristics 106 within the modeled object or structure 104. In some embodiments, the 3D model 102 may include graphical representations, including 2D and 3D graphical representations, indicating and/or modeling the various characteristics 106 within the modeled object of structure 104. The various characteristics 106 may include structural characteristics, which may include characteristics of the materials defining the object or structure 104. For example, the various characteristics may include inconsistencies, defects, and/or discontinuities. More specifically, the various characteristics may include a delamination, a resin pocket, a structural feature, a defect, a pocket of unexpected material, a volume lacking an expected material, an inconsistency, a void, an air bubble, an unexpected change in material and/or structure, and/or some other type of change in the structure, or combinations thereof.

The three-dimensional model 102 may be viewable on a display device, for example, a computer monitor.

As noted above, in some embodiments, one or more of the inspection systems 108 or the location systems 110 may include local storage for storing data from the respective inspection system 108 or location system 110 as the scan of the structure is being completed. At a selected time or interval (e.g., selected intervals during the scan, at the end of the scan) the data from the respective inspection system 108 or location system 110 may be transmitted to another portion of the system 100 (e.g., the data processing system 112).

While certain illustrative embodiments have been described in connection with the figures, those of ordinary skill in the art will recognize and appreciate that the scope of this disclosure is not limited to those embodiments explicitly shown and described in this disclosure. Rather, many additions, deletions, and modifications to the embodiments described in this disclosure may be made to produce embodiments within the scope of this disclosure, such as those specifically claimed, including legal equivalents. In addition, features from one disclosed embodiment may be combined with features of another disclosed embodiment while still being within the scope of this disclosure, as contemplated by the inventors.

1. A system for generating a digital model of a structure indicating at least one characteristic of the structure, the system comprising:
an inspection system configured to:
detect structural information of the structure through a depth of the structure and to generate model depth data; and
detect the at least one characteristic of the structure and generate characteristic data;
a location system in communication with the inspection system, wherein the location system is configured to track a location of at least a portion of the inspection system and generate inspection system location data, wherein the location data comprises data relating to a position of the at least a portion of the inspection system relative to the structure along at least three degrees of freedom; and
a data processing system in communication with the inspection system and the location system, wherein the data processing system is configured to:
generate the digital model of the structure using the model depth data, the characteristic data, and the location data in which an indication of the at least one characteristic is visible in the digital model, wherein one or more locations of the at least one characteristic in the digital model substantially correspond to one or more locations of the at least one characteristic in the structure.

2. The system of claim 1, wherein the inspection system comprises:
a platform configured to move on or over a surface of the structure; and
a transducer system coupled to the platform configured to send signals into the structure and receive a response to the signals.

3. The system of claim 2, wherein the transducer system comprises an array of transducers, and wherein the transducer system further comprises a cylindrical housing configured to roll on the surface of the structure as the platform moves along the surface of the structure, wherein the array of transducers is located within the cylindrical housing.

4. The system of claim 1, wherein the inspection system is configured to send a movement signal to the data processing system upon movement of the at least a portion of the inspection system.

5. The system of claim 4, wherein, upon receiving the movement signal, a portion of the system is configured to send a trigger signal to one or more of the inspection system or the location system to send data relating to the structure to the data processing system.

6. The system of claim 5, further comprising a triggering device configured to receive the movement signal from the inspection system and to transmit the trigger signal to the one or more of the inspection system or the location system.

7. The system of claim 1, wherein the location system is configured to define the location data as a point relating to the location of the at least a portion of the inspection system on a surface of the structure.

8. The system of claim 7, wherein the inspection system is configured to detect the structural information through the depth of the structure at the point extending from the surface to an opposing distal surface of the structure.

9. The system of claim 1, wherein:
the location system comprises a laser tracker; and
the inspection system comprises:
a platform configured to move over a surface of the structure;
a transducer system configured to send signals into the structure and receive a response to the signals from the structure; and
a target point coupled to the platform configured to be detected by the laser tracker.

10. The system of claim 1, wherein the location data comprises translation data relating to position along three perpendicular axes and rotation data about the three perpendicular axes.

11. The system of claim 1, wherein the data processing system is configured to generate a three-dimensional model of the structure.

12. A system for generating a digital three-dimensional model of a structure showing one or more defects in the structure, the system comprising:
an inspection device comprising:
a platform configured to move along a surface of the structure; and
a transducer system configured to send signals into the structure and receive a response to the signals from the structure;
a positional tracker in communication with the inspection device; and
a data processing system in communication with the positional tracker and with the inspection device;
wherein the inspection device is configured to detect structural information including the one or more defects in the structure and generate structural information data;
wherein the positional tracker is configured to generate inspection device location data, the location data comprising data relating to a position of the inspection device about six degrees of freedom of the inspection device; and
wherein the data processing system is configured to:
generate the digital three-dimensional model of the structure using the structural information data and the location data in which an indication of the one or more defects is indicated in the digital model at a location within the digital model that substantially corresponds to a location of the one or more defects in the structure.

13. The system of claim 12, wherein the platform comprises a handheld platform configured to be manually rolled along and over a surface of the structure, and wherein the positional tracker is positioned on and coupled to the handheld platform.

14. The system of claim 12, wherein the positional tracker is configured to generate the inspection device location data comprising a plurality of points, each point correlating to a position on the surface of the structure.

15. The system of claim 14, wherein the inspection device is configured to detect structural information through a thickness of the structure at each point of the plurality of points.

16. The system of claim 15, wherein the data processing system is configured to generate the digital model based, at least in part, on the structural information of the structure at each point of the plurality of points.

17. A method for generating a digital model of an object indicating one or more discontinuities in the object, the method comprising:
moving an ultrasonic inspection device along a surface of the object;
emitting ultrasonic signals into the object with the ultrasonic inspection device and receiving return signals with the ultrasonic inspection device;
detecting from the emitted and the return signals, with the ultrasonic inspection device, the one or more discontinuities in the object from a response from the ultrasonic inspection device;
generating discontinuity data based on the response from the ultrasonic inspection device;
communicating, from the ultrasonic inspection device, the discontinuity data to a data processing system remote from the ultrasonic inspection device;
tracking a location of the ultrasonic inspection device relative to the object and generating location data with a tracking system;
communicating the location data to the data processing system; and
generating, with the data processing system, the digital model using the discontinuity data and the location data in which an indication of the one or more discontinuities is visible in the digital model and a location of the one or more discontinuities in the digital model is positioned in the model substantially at a location of the one or more discontinuities in the object.

18. The method of claim 17, further comprising:
detecting structural information extending through depths of the object from the surface to an opposing distal surface using the emitted and return ultrasonic signals; and
communicating the structural information extending through the depths to the data processing system to generate the digital model.

19. The method of claim 17, further comprising selecting the location data to comprise position data along three axes of movement of the ultrasonic inspection device relative to the tracking system.

20. The method of claim 19, further comprising selecting the location data to further comprise rotational data of the ultrasonic inspection device about the three axes of movement.

21. The method of claim 17, wherein the tracking system comprises a laser tracking system, and further comprising generating the location data from a portion of the laser tracking system that is associated with the inspection device.
